(19) United States
(12) Patent Application Publication
(10) Pub. No.: US 2017/0307129 A1
(43) Pub. Date: Oct. 26, 2017

(54) POWER TAKEOFF SUPPORT SYSTEMS AND METHODS

(71) Applicant: Muncie Power Products, Inc., Muncie, IN (US)

(72) Inventors: John Rinkenbaugh, Collinsville, OK (US); David Freeman, Claremore, OK (US)

(73) Assignee: Muncie Power Products, Inc., Muncie, IN (US)

(21) Appl. No.: 15/489,982

(22) Filed: Apr. 18, 2017

Related U.S. Application Data
(60) Provisional application No. 62/325,209, filed on Apr. 20, 2016.

(51) Int. Cl. F16M 1/04; F16B 2/10; F16M 13/02; B60K 25/06

(52) U.S. Cl. CPC F16M 1/04; F16M 13/022; F16B 2/10; B60K 25/06

(57) ABSTRACT

PTO support systems are disclosed. Embodiments include a bracket with a receiving portion, and an optional enclosing member. When connected, the receiving portion of the bracket and the enclosing member cooperatively retain a PTO shaft while in operation, and may also allow the shaft to move in the direction of the axis of the shaft. The bracket may be easily attached to a transmission housing or motor vehicle frame. Once attached, a user may place the shaft onto the receiving portion of the bracket, which is configured to at least temporarily retain the shaft, in order to avoid the need for the user to manually support the weight of the shaft while simultaneously attaching the enclosing member to the bracket.

This application claims the benefit of priority to U.S. Provisional Patent Application No. 62/325,209, filed Apr. 20, 2016, entitled POWER TAKEOFF SUPPORT SYSTEMS AND METHODS, the entirety of which is incorporated herein by reference.

### FIELD

This disclosure relates to power takeoff devices (PTOs) useful for mounting on transmissions and for performing, directly or indirectly, useful work via the PTO's rotatable output shaft. More particularly, this disclosure relates to a support for a PTO shaft extension system configured to assist with installation of the PTO, allow the shaft to slide axially, or both.

### BACKGROUND

The use of a PTO in association with vehicle (e.g., truck) or stationary engine transmissions is generally known. Such PTOs often include an input gear for connection to an input shaft or transmission, an output gear for connection to an output shaft and, optionally, a clutch mechanism for selectively engaging and disengaging power to the output shaft so as to selectively rotate the output shaft of the PTO to perform useful work, such as to power an auxiliary device. Once connected to a gear within the transmission, the input gear of the PTO is connected to and can draw mechanical power from the transmission.

Installing an auxiliary device such as a hydraulic pump to a transmission-mounted PTO is often constrained by inadequate space or room between the truck frame, suspension components, exhaust components and the side of the transmission body itself. In such cases, the auxiliary device can be located behind the transmission where there is adequate room. The auxiliary device can then be pedestal-mounted and driven by an open shaft, but this is undesirable because of the maintenance and inherent danger of open shafts. A shaft extension assembly, generally known in the industry, is a long housing that mounts directly to the PTO and extends from the PTO to the auxiliary device located behind the transmission or at another location with adequate room to fit the auxiliary device. Within the housing is an elongated shaft that provides a rotating connection between the PTO output shaft and the input drive of the auxiliary device. Alternatively, the PTO itself can be located behind the transmission and operatively connected to the transmission via an output shaft within a shaft extension housing, the output shaft extending between a transmission mounting gear at one end of the housing and a PTO at an opposite end of the shaft extension housing.

This shaft extension housing is preferably supported at the rear of the transmission or at another location along the length of the housing to reduce the bending moment on the transmission. This reduction of the bending moment is particularly beneficial when the shaft extension housing extends to a relatively heavy PTO or relatively heavy auxiliary device remote from the transmission. The support system is preferably vertically stiff while being linearly compliant to accommodate manufacturing tolerances and temperature growth differences between the transmission housing and shaft extension housing. To provide this linear compliance, existing art involves multiple fasteners with bushings or other means of allowing the bracket to freely slide fore and aft with respect to the transmission. Existing art also sometimes results in a housing and support system assembly that is longer than absolutely necessary if the support system were simpler.

Installing a PTO shaft and/or PTO housing (e.g., the PTO housing may be attached to the PTO shaft before or after installation of the PTO shaft) can be strenuous or even dangerous. Typically, a user must support heavy parts, such as a PTO shaft and/or PTO housing, over the user's head during installation. For example, a user would be obligated to either attach the bracket to the transmission housing then support the PTO shaft housing while securing the PTO shaft housing to the bracket, or attach the bracket to the PTO shaft housing then support the bracket and PTO shaft housing while securing the bracket to the transmission housing.

Supporting a PTO input shaft or output shaft can also be difficult since the shaft can move back and forth in the direction of the axis of the shaft, such as when the shaft expands and contracts at a different rate than the transmission. Supporting a shaft in a manner that prohibits the shaft from sliding in the direction of the axis of the shaft can create strain on the shaft and the support.

The inventors of the present disclosure realized that improvements in support systems for PTO components are needed. Certain preferred features of the present disclosure address these and other needs and provide other important advantages.

### SUMMARY

Embodiments of the present disclosure simplify the process of mounting an extended shaft system to a PTO and can reduce the amount of time a user must support the weight of the shaft while mounting an extended shaft system and/or a PTO to, for example, a transmission. Instead of lifting and supporting the shaft during installation, a user may lift a shaft onto the receiving portion of the disclosed bracket such that the bracket supports the weight of the shaft while the user secures the shaft to the transmission.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions or may have been created from scaled drawings. However, such dimensions, or the relative scaling within a figure, are by way of example only, and are not to be construed as limiting the scope of this invention.

FIG. 1 is a perspective view of a PTO support system according to one embodiment of the present invention.

FIG. 2 is an alternate perspective view, displaying the opposite side of the support system depicted in FIG. 1.

FIG. 3 is a perspective view of the PTO support system depicted in FIG. 1 mounted on a transmission and supporting a shaft extension system.

FIG. 4 is an alternate perspective view, displaying the opposite side of the mounted support system depicted in FIG. 3.

FIG. 5 is an exploded perspective view of a PTO support system according to another embodiment of the present invention.

FIG. 6 is a perspective view of the support system depicted in FIG. 5 engaged with a PTO shaft extension system.

FIG. 7 is a perspective view of the support system depicted in FIG. 5 mounted on a transmission and supporting an extended PTO shaft.

FIG. 8 is a partial end perspective view of the support system depicted in FIG. 7.

FIG. 9 is a perspective view of a PTO support system according to a further embodiment of the present invention.

FIG. 10 is an alternate perspective view, displaying the opposite side of the support system depicted in FIG. 9.

FIG. 11 is a perspective view of the PTO support system depicted in FIG. 9 mounted on a transmission and supporting a shaft extension system.

FIG. 12 is an alternate perspective view, displaying the opposite side of the mounted support system depicted in FIG. 11.

### DETAILED DESCRIPTION OF THE ILLUSTRATED EMBODIMENTS

For the purposes of promoting an understanding of the principles of the invention disclosed herein, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages, or may include different benefits or advantages. Any benefits or advantages described herein are not to be construed as limiting to any of the claims.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

Embodiments of the present invention include PTO support systems for PTO extended shafts that may assist with installation of a PTO and/or a PTO extended shaft, and may allow the shaft to move axially.

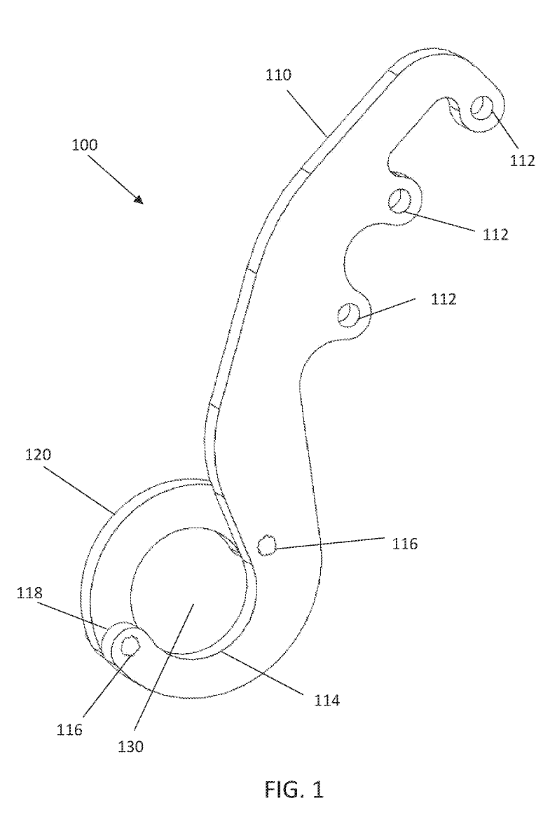

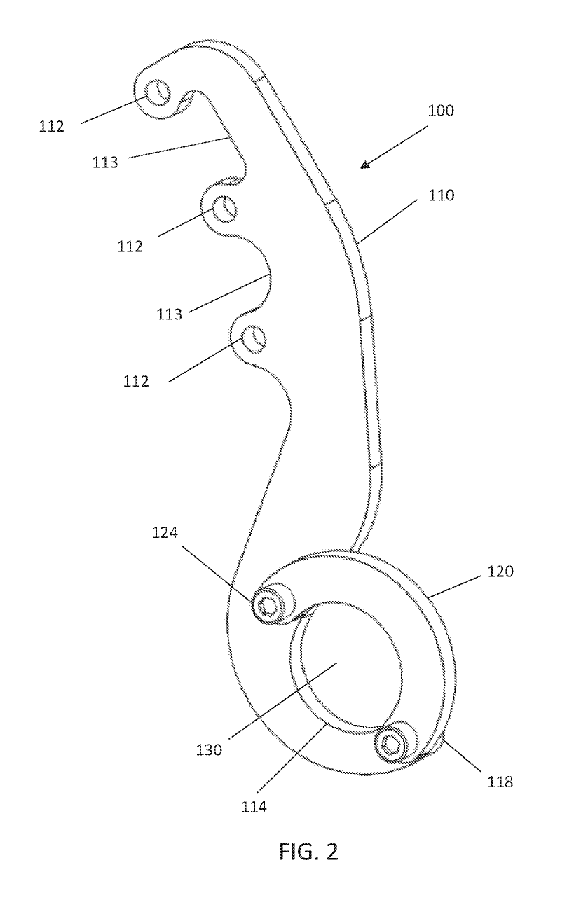

Depicted in FIGS. 1 and 2 is a support system 100 according to one embodiment of the present invention. Support system 100 includes a bracket 110 and an enclosing member 120. Bracket 110 includes mounting features, e.g., apertures 112, which are used to mount bracket 110 to a transmission housing or other member, such as a frame of a motor vehicle. In some embodiments, elongated fasteners, e.g., bolts (not shown), are inserted through apertures 112 and into corresponding apertures on the transmission housing or frame of a motor vehicle to secure the bracket 110 to the transmission housing or frame. Bracket 110 further includes a receiving portion 114 (which may resemble a cradle in some embodiments), for receiving and supporting a portion of a PTO shaft, PTO housing, or other PTO component. In the illustrated embodiment, the rear profile of bracket 110 resembles the letter “J” with receiving portion 114 being the hooked part of the “J,” and terminating in a raised end 118. In other embodiments, the rear profile of the bracket may resemble the mirror image of the letter “J” or the hooked portion may be extended such that the rear profile of the bracket resembles the letter “U.”

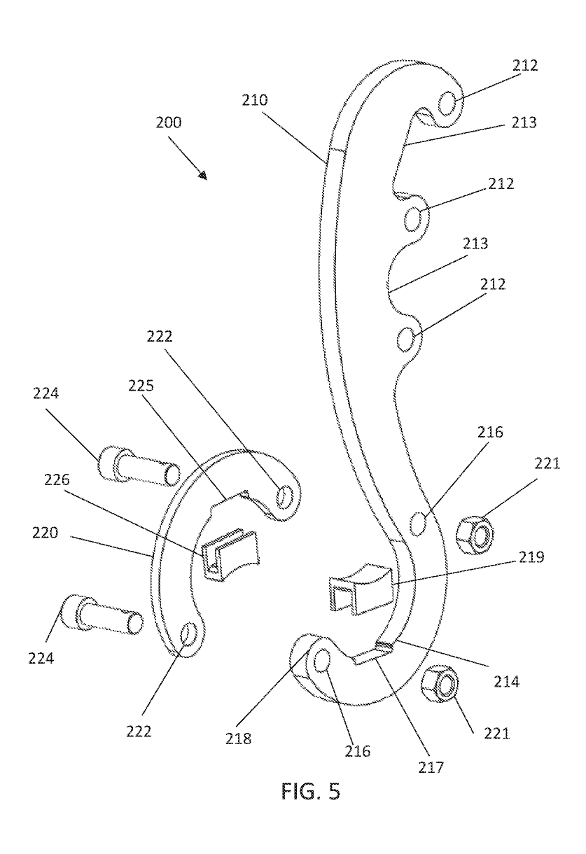

Enclosing member 120 is attached to the bracket 110 to cooperatively retain the extended shaft housing. Enclosing member 120 includes mounting features, e.g., apertures 122 (not depicted in FIGS. 1 and 2), which are used to mount enclosing member 120 to bracket 110. While the apertures 122 are obscured by the bracket 110 in FIG. 1 and by the bolts 124 in FIG. 2, they correspond to aperture 222 shown in FIG. 5. In the embodiment depicted in FIGS. 1 and 2, elongated fasteners, e.g., bolts 124, are inserted through apertures 122 in the enclosing member 120, and into corresponding apertures 116 in the bracket. In other embodiments, the enclosing member 120 may be hingedly attached to the bracket 110, for example, by using a pivot pin or similar device. In the depicted embodiment, the rear profile of the enclosing member 120 resembles the letter “C.” Together, the rear profiles of the bracket 110 and enclosing member 120 resemble the lowercase letter “d,” as shown in FIG. 1, with the bracket 110 and enclosing member 120 cooperatively forming an opening 130. Opening 130 is preferably sized to surround the circumference of a PTO extended shaft housing extending through the opening 130. With this arrangement, support system 100 may support the extended shaft housing and restrict the housing's motion in radial directions while allowing the housing to move in the direction of the axis of the shaft, the axes of the shaft and shaft housing being substantially perpendicular to the circumferences of the shaft and shaft housing. In alternative embodiments, opening 130 may snugly surround the circumference of the PTO shaft housing, and resist axial movement of the shaft housing. In further embodiments, the bracket and enclosing member may cooperatively form an opening configured to surround the PTO. In certain embodiments, the rear profiles of the bracket and enclosing member may resemble the lowercase letter “b” or may resemble a combination of the letter “U” (the bracket) and the letter “C” with the opening of the letter facing downward (the enclosing member).

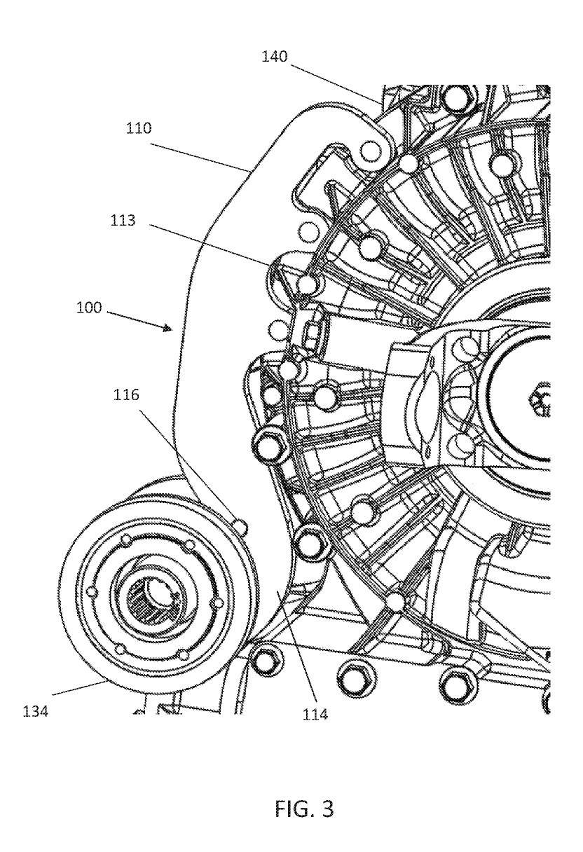

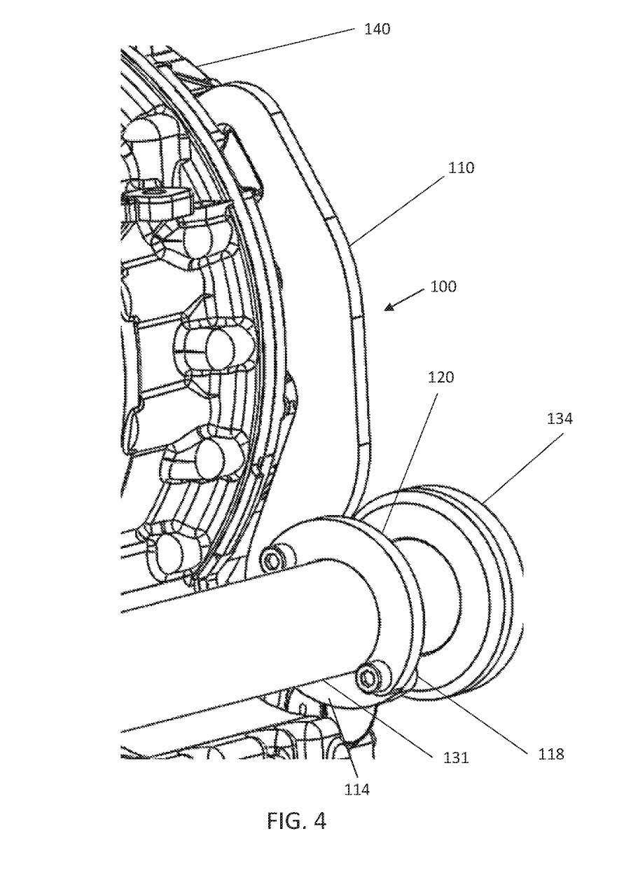

Embodiments of the present disclosed invention simplify the process of mounting an extended shaft system to a PTO, and can reduce the length of time a user must manually support the weight of the shaft while mounting an extended shaft system and/or a PTO to, for example, a transmission. Typically, a user must support heavy parts, e.g., a PTO extended shaft housing or along PTO housing system, over the user's head during installation. Compared to a PTO extended shaft housing, bracket 110 is light, easily maneuverable, and relatively easy to mount to a transmission or other member, such as a motor vehicle frame. For example, as depicted in FIGS. 3 and 4, bracket 110 may be mounted to the transmission housing 140 in a substantially upright orientation, with receiving portion 114 disposed downwardly. With the bracket 110 in this orientation, a user may simply lift a shaft housing 131 up and over the raised end 118 of bracket 110, then lower the shaft housing 131 to rest the shaft housing 131 on the receiving portion 114. Raised end 118 extends above the middle part of the receiving portion 114, such that contact with the raised end 118 prevents the shaft housing 131 from moving laterally out of the receiving portion 114. The user may then simply attach the enclosing member 120 to the bracket 110 without needing to support the shaft housing 131 at the same time. In some embodiments, the enclosing member 120 may be hingedly attached or otherwise attached to the bracket 110 prior to positioning the shaft housing 131 on the receiving portion 114. In such embodiments, the enclosing member 120 may be rotated or otherwise moved to enclose the shaft after the shaft is positioned on the receiving portion 114. The curved cradle-like shape of the receiving portion 114 and raised end 118 reduces the risk that the shaft housing 131 may slide off the bracket 110 in a lateral direction while the enclosing member 120 is attached or repositioned to surround the shaft cooperatively with the bracket 110.

In other embodiments, the receiving portion may be substantially flat. In such embodiments, the receiving portion may optionally include friction elements to hinder the shaft from sliding off the bracket in a lateral direction. In such embodiments, the receiving portion may optionally include a raised end to prevent the shaft from sliding off the bracket in a lateral direction.

In FIGS. 3 and 4, the support system 100 is attached to a transmission housing 140 and supports a shaft housing 131 at a longitudinal station along the length of the shaft housing 131 between a PTO (not shown) at one end of the shaft housing 131 and a receiving end 134 for receiving a driven device, such as a pump or other auxiliary device, at an opposite end of the shaft housing 131. In other embodiments (not shown), the support system 100 is attached to a transmission housing 140 or motor vehicle frame and supports an output shaft housing at a longitudinal station along the length of the output shaft between a transmission mounting gear at one end of the output shaft housing and a PTO at an opposite end of the output shaft housing. In other embodiments, the support system 100 supports the shaft housing at a different longitudinal station.

In the depicted embodiment, bracket 110 includes one or more optional indentations 113. As shown in FIGS. 3 and 4, the indentations 113 may be positioned and sized to accommodate structures protruding from the transmission housing 140 to avoid mechanical interference between the bracket 110 and the transmission housing 140 and/or to accommodate differences in the expansion or contraction of transmission housing 140 and bracket 110 as they increase and decrease in temperature during operation.

The disclosed support system 100 is configured to support the shaft housing 131 (shown best in FIG. 4) during use of the PTO, i.e., while the shaft within housing 131 is operational and rotating. In the depicted embodiments, support system 100 directly contacts the non-rotating extended shaft housing 131 with the rotating shaft located within the shaft housing 131. In some embodiments, the support system may directly contact the rotating shaft. In such embodiments, the bracket and, optionally, the enclosing member, may include a friction-reducing coating or a friction-reducing mechanism, such as ball bearings positioned between the bracket and the rotating shaft.

In alternate embodiments, instead of a cylindrical shaft housing, the shaft may be enclosed within a shaft housing with a square, rectangular, or other non-circular geometrical cross-section. In some embodiments, the bracket and enclosing member will be configured with an opening geometry corresponding generally to the cross-sectional shape of the shaft housing, e.g., a square opening for receiving a shaft housing with a square cross-section. In other embodiments, however, the bracket and enclosing member may be configured with an opening having a non-matching geometry, e.g., a triangular opening for receiving a shaft housing with a hexagonal cross section.

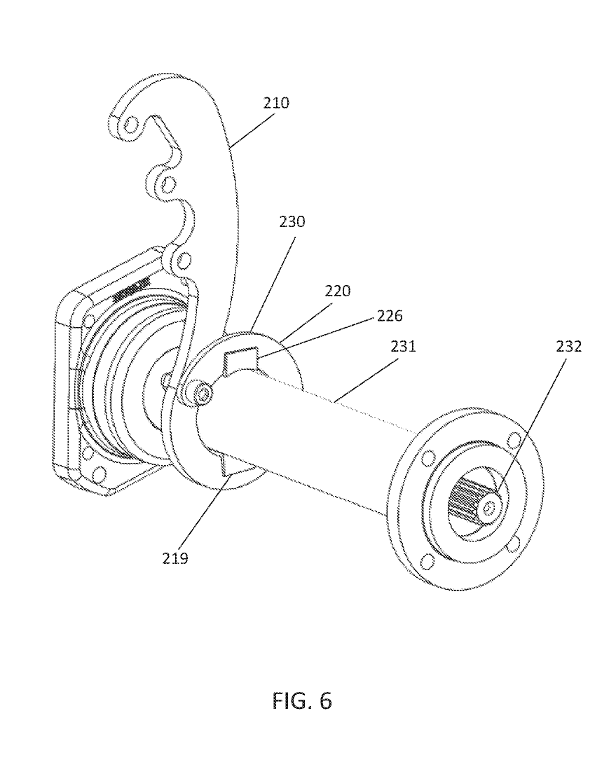

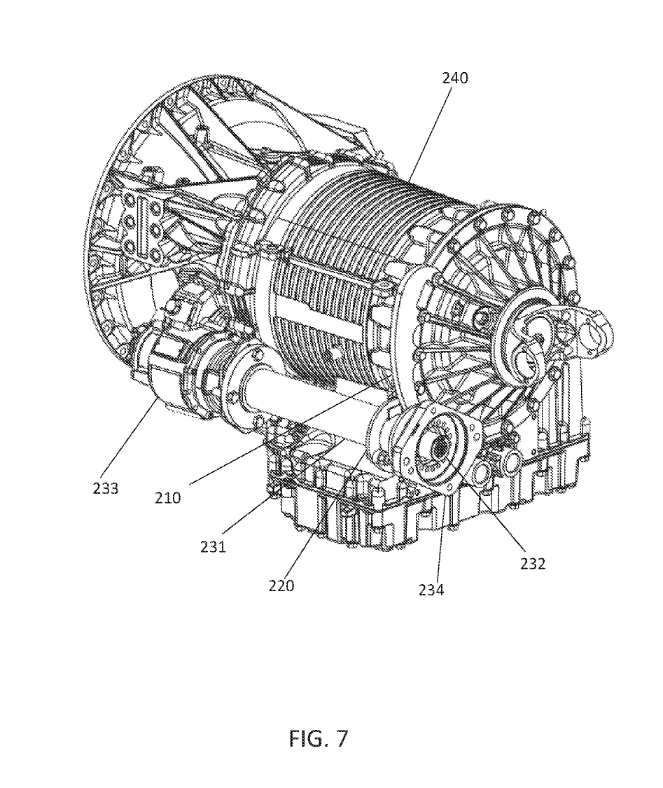

Depicted in FIGS. 5-8 is a support system 200 according to another embodiment of the present invention. Support system 200 includes a bracket 210 and an enclosing member 220. Bracket 210 includes mounting features, e.g., apertures 212, which are used to mount bracket 210 to a transmission housing or other member, such as a frame of a motor vehicle. In some embodiments, elongated fasteners, e.g., bolts (not shown), are inserted through apertures 212 and into corresponding apertures on the transmission housing or frame of a motor vehicle to secure the bracket 210 to the transmission housing or frame. In this embodiment, the bracket 210 includes one or more optional indentations 213. As shown in FIGS. 6-7, the indentations 213 may be positioned and sized to accommodate structures protruding from the transmission housing 240 to avoid mechanical interference between the bracket 210 and the transmission housing 240. Bracket 210 further includes a receiving portion 214 (which may resemble a cradle in some embodiments), for receiving and supporting a portion of a PTO extended shaft housing or other PTO component. In this illustrated embodiment, the rear profile of bracket 210 resembles the letter “J” with receiving portion 214 being the hooked part of the “J,” and terminating in a raised end 218. In some embodiments, the raised end 218 is configured to retain the shaft housing 231, and inhibit lateral movement of the shaft housing 231 when the bracket 210 is attached to the transmission housing 240.

Enclosing member 220 is attached to the bracket 210 to cooperatively retain the shaft housing 231, as shown in FIGS. 6-8. Enclosing member 220 includes mounting features, e.g., apertures 222, which are used to mount enclosing member 220 to bracket 210. In the embodiment depicted in FIGS. 5-8, elongated fasteners, e.g., bolts 224, are inserted through apertures 222 in the enclosing member 220, into corresponding apertures 216 in the bracket 210, and secured using nuts 221. In further embodiments, the fasteners may be dowel pins and cotter pins, bolts fitted into threaded apertures, or other attachment means known in the art. In other embodiments, the enclosing member 220 may be hingedly attached to the bracket 210, for example, by using a pivot pin or similar device. In the depicted embodiment, the rear profile of the enclosing member 220 resembles the letter “C.” Together, the rear profiles of the bracket 210 and enclosing member 220 resemble the lowercase letter “d” when viewed from the rear, as shown in FIGS. 5, 7 and 8, and the lowercase letter “b” when installed in a reverse orientation and viewed from the rear, as shown in FIG. 6, with the bracket 210 and enclosing member 220 cooperatively forming an opening 230.

Opening 230 is preferably sized to surround the circumference of the shaft housing 231 extending therethrough. With this arrangement, support system 200 may support the shaft housing 231 and the shaft 232 at least partially enclosed within, and restrict radial motion of the shaft housing 231 while allowing the shaft housing 231 to move axially. In alternative embodiments, opening 230 may snugly surround the circumference of the PTO extended shaft housing, and resist movement of the PTO extended shaft housing in the direction of the axis of the shaft. In further embodiments, the bracket and enclosing member may cooperatively form an opening configured to surround the PTO.

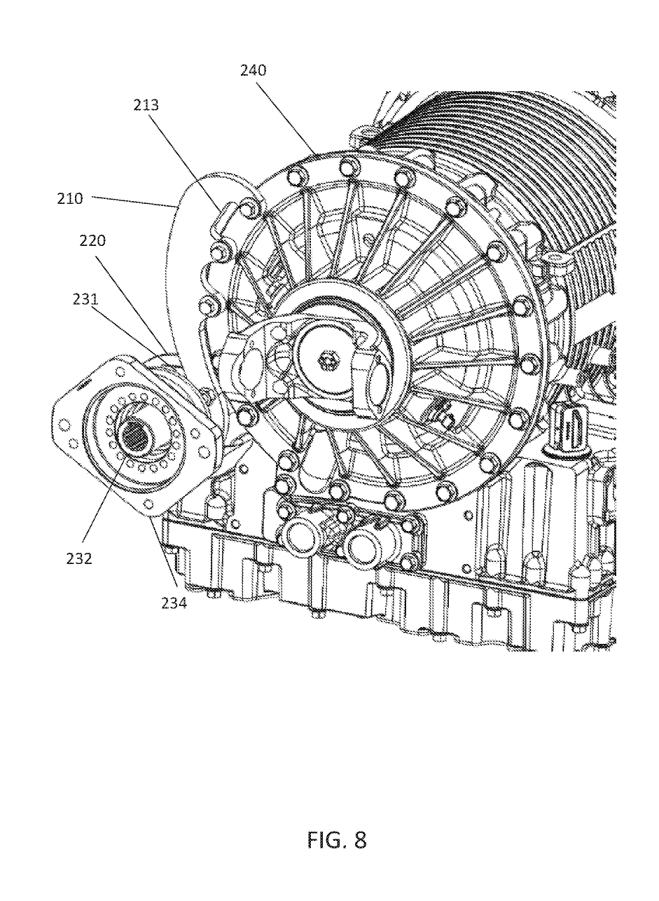

In some embodiments, as shown in FIGS. 7 and 8, the support system 200 is attached to a transmission 240 and supports a shaft housing 231 and an extended shaft 232 (not visible within the shaft housing 232) at a longitudinal station along the length of the shaft housing 231 between a transmission mounting gear 233 at one end of the shaft housing 231 and a receiving end 234 for receiving a driven device, such as a pump, at an opposite end of the shaft housing 231. In other embodiments (not shown), support system 200 is attached to a transmission 240 or motor vehicle frame and supports an extended shaft and shaft housing at a longitudinal station along the length of the shaft between a PTO at one end of the shaft and an auxiliary device at an opposite end of the shaft. In other embodiments, the support system 200 supports the shaft at a different longitudinal station.

In the embodiment illustrated in FIGS. 5-8, the receiving portion 214 includes an optional first cutout portion 217 and the enclosing member 220 includes an optional second cutout portion 225. First cutout portion 217 may be sized and shaped to receive a first saddle 219, which provides the receiving portion 214 with a substantially smooth and curved surface. Similarly, second cutout portion 225 may be sized and shaped to receive a second saddle 226, which provides the enclosing member 220 with a substantially smooth and curved surface. In some embodiments, saddles 219, 226 are manufactured of a low-friction material or include a low-friction coating to reduce risk of seizure, fretting corrosion, and wear and tear on shaft housing 231 extending through the opening 230 as the shaft housing 231 moves axially, or as the system heats and cools and the shaft housing 231 and support system 200 expand and contract. In some embodiments, the saddles are manufactured of a low-friction non-ferrous material. In certain embodiments (not shown), the support system may include only a single cutout and a single saddle. In further embodiments, the support system may include a plurality of cutout portions and corresponding saddles spaced around the circumference of the opening.

As described in connection with the support system 100, the support system 200 also simplifies the process of mounting an extended shaft housing to a PTO and can dramatically reduce the amount of time a user must support the weight of the extended shaft housing while mounting an extended shaft housing and/or a PTO to, for example, a transmission. As depicted in FIGS. 7-8, bracket 210 may be mounted to the transmission 240 in a substantially upright orientation, with receiving portion 214 disposed downwardly. With the bracket 210 in this orientation, a user may lift an extended shaft housing 231 up and over the raised end 218 of the bracket 210, then simply lower the extended shaft housing 231 to rest on the receiving portion 214. The raised end 218 extends above the middle part of the receiving portion 214 when installed such that contact with the raised end 218 prevents the shaft housing 231 from moving laterally or “sliding” out of receiving portion 214. With the shaft housing 231 cradled and supported within the receiving portion 214 of the bracket 210, shaft housing 231 may then be slid toward and fastened to the PTO 233. The user may then attach the enclosing member 220 to the bracket 210 without needing to support the extended shaft housing 231 at the same time. The extended shaft 232 may be inserted into the shaft housing 231 before the shaft housing 231 is placed on the receiving portion 214, or may be inserted into the shaft housing 231 after the shaft housing 231 is placed on the receiving portion 214 to reduce the weight lifted by the user.

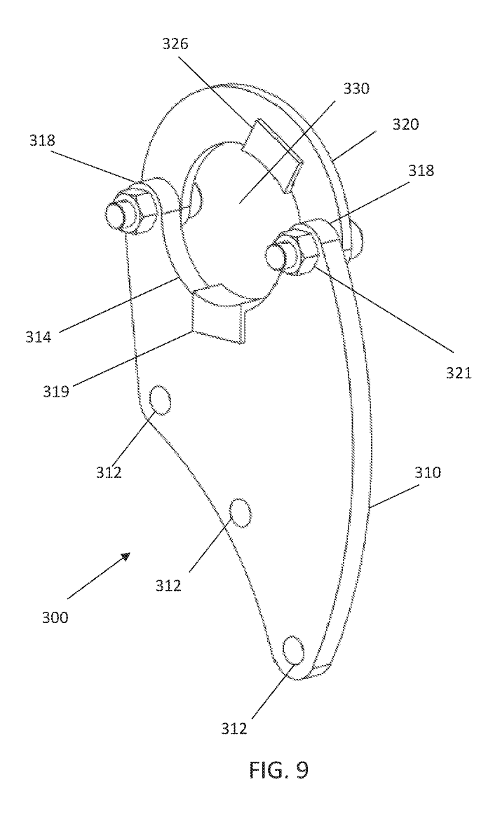

Depicted in FIGS. 9-12 is a support system 300 according to yet another embodiment of the present invention. Support system 300 includes a bracket 310 and an enclosing member 320. Bracket 310 includes mounting features, e.g., apertures 312, which are used to mount bracket 310 to a transmission housing or other member, such as a frame of a motor vehicle. In some embodiments, elongated fasteners, e.g., bolts (not shown), are inserted through apertures 312 and into corresponding apertures on the transmission housing or frame of a motor vehicle to secure the bracket 310 to the transmission housing or frame. Bracket 310 further includes a receiving portion 314 (which may resemble a cradle in some embodiments), for receiving and supporting a portion of a PTO extended shaft housing or other PTO component. In the illustrated embodiment, the rear profile of the receiving portion 314 of bracket 310 resembles the letter “U” with raised ends 318 on either side of the receiving portion 314. In some embodiments, the raised ends 318 are configured to retain the shaft housing 331, and inhibit lateral movement of the shaft housing 331 when the bracket 310 is attached to the transmission housing 340.

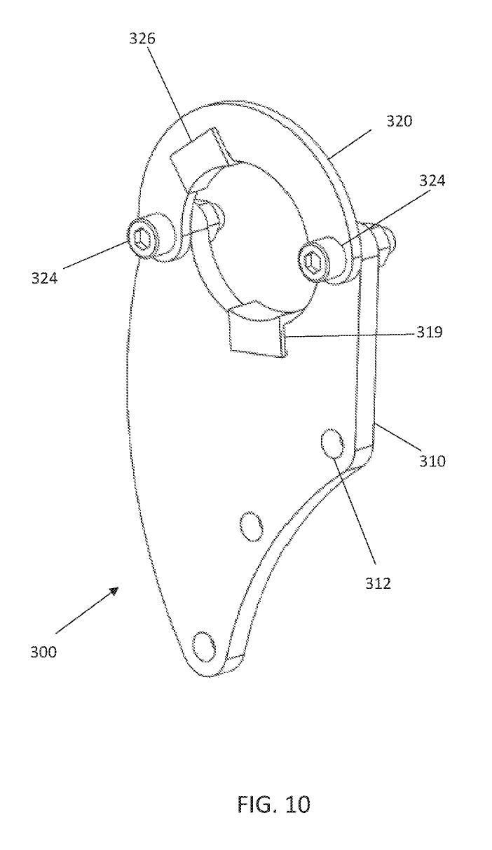

Enclosing member 320 is attached to the bracket 310 to cooperatively retain the shaft housing 331. Enclosing member 320 includes mounting features, e.g., apertures 322, which are used to mount enclosing member 320 to bracket 310. The apertures 322 are obscured by the bolts 324 in FIG. 10 and by the bracket 310 in FIG. 9. Elongated fasteners, e.g., bolts 324, are inserted through apertures 322 in the enclosing member 320, into corresponding apertures 316 in the bracket, and secured using nuts 321. In further embodiments, the fasteners may be dowel pins and cotter pins, bolts fitted into threaded apertures, or other attachment means known in the art. In other embodiments, enclosing member 320 may be hingedly attached to the bracket 310, for example, by using a pivot pin or similar device.

In the depicted embodiment, the rear profile of the enclosing member 320 resembles a downward facing letter “C.” Together, the bracket 310 and enclosing member 320 cooperatively form an opening 330. Preferably, opening 330 is sized to surround the circumference of the shaft housing 331 extending through the opening 330. With this arrangement, the support system 300 may support the shaft housing 331 and the shaft at least partially enclosed within, and restrict radial motion of the shaft housing 331 while allowing the shaft housing 331 to move axially. In alternative embodiments, the opening 330 may snugly surround the circumference of the PTO extended shaft housing, and resist movement of the PTO extended shaft housing in the direction of the axis of the shaft. In further embodiments, the bracket and enclosing member may cooperatively form an opening configured to surround the PTO.

As best shown in FIGS. 9 and 10, receiving portion 314 includes an optional first cutout portion and the enclosing member 320 includes an optional second cutout portion. First cutout portion may be sized and shaped to receive therein a saddle 319, which provides receiving portion 314 with a substantially smooth and curved surface. Similarly, second cutout portion may be sized and shaped to receive a second saddle 326, which provides the enclosing member 220 with a substantially smooth and curved surface. In some embodiments, the optional first and second cutouts are similar in size and shape to cutouts 217, 225. The optional first and second cutouts are not visible in FIGS. 9-12, as the cutouts are obscured by the saddles 319, 326 or by shaft housing 331. In some embodiments, saddles 319, 326 are manufactured of a low-friction material or include a low-friction coating to reduce risk of seizure, fretting corrosion, and wear and tear on shaft housing 331 extending through the opening 330 as the shaft housing 331 moves axially, or as the system heats and cools and the shaft housing 331 and support system 300 expand and contract. In some embodiments, the saddles are manufactured of a low-friction non-ferrous material. In certain embodiments (not shown), the support system may include only a single cutout and a single saddle. In further embodiments, the support system may include a plurality of cutout portions and corresponding saddles spaced around the circumference of the opening.

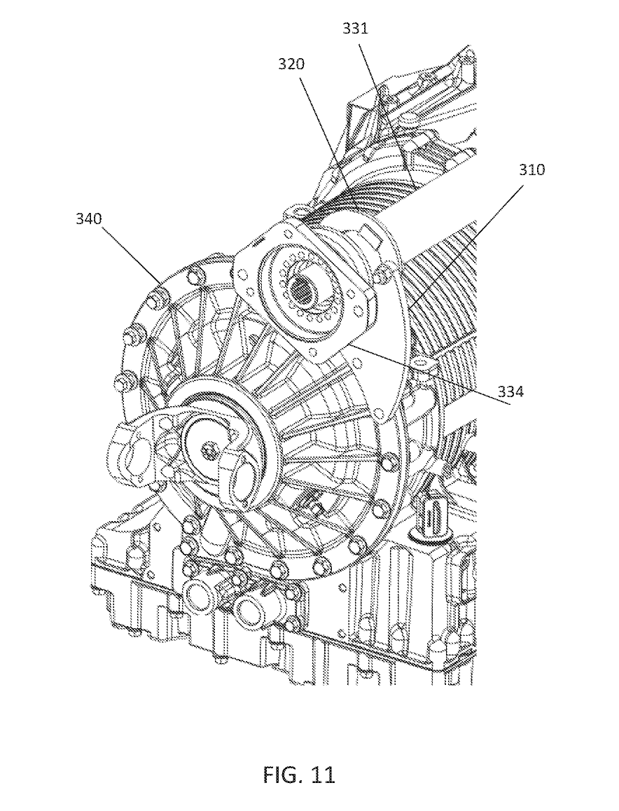

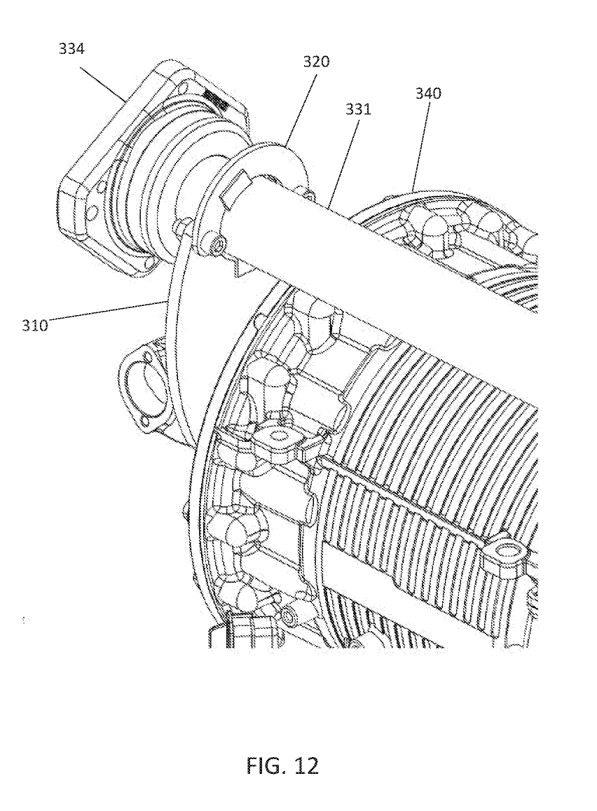

In some embodiments, as shown in FIGS. 11 and 12, support system 300 is attached to a transmission 340 and supports a shaft housing 331 at a longitudinal station along the length of the shaft housing 331 between a PTO (not shown) at one end of the shaft housing 331 and a receiving end 334 for receiving a driven device, such as a pump or other auxiliary device, at an opposite end of the shaft housing 331. In other embodiments (not shown), support system 300 is attached to a transmission 340 or motor vehicle frame and supports an extended shaft and shaft housing at a longitudinal station along the length of the shaft between a transmission mounting gear at one end of the shaft and a PTO at an opposite end of the shaft. In other embodiments, support system 300 supports the shaft at a different longitudinal station.

As described in connection with support systems 100, 200, support system 300 also simplifies the process of mounting an extended shaft housing to a PTO and can dramatically reduce the amount of time a user must support the weight of the extended shaft housing while mounting an extended shaft housing and/or a PTO to, for example, a transmission. As depicted in FIGS. 11-12, bracket 310 may be mounted to the transmission 340 in a substantially upright orientation, with receiving portion 314 facing upwardly. With the bracket 310 in this orientation, a user may simply lower an extended shaft housing 331 between the raised ends 318 of the bracket 310 to rest the shaft housing 331 within receiving portion 314. The raised ends 318 extend above the middle part of the receiving portion 314 when installed, such that contact with the raised ends 318 prevent the shaft housing 331 from moving laterally or sliding out of receiving portion 314. With the shaft housing 331 cradled and supported within the receiving portion 314 of bracket 310, the shaft housing 331 may then be slid toward and fastened to the PTO (not shown). The user may then simply attach the enclosing member 320 to the bracket 310 without needing to simultaneously support the extended shaft housing 331. The extended shaft (not shown) may be inserted into the shaft housing 331 before the shaft housing is placed within receiving portion 314, or may be inserted into the shaft housing 331 after shaft housing 331 is placed within receiving portion 314 to reduce the weight lowered by the user.

Alternate embodiments of the present disclosure include a support system without an enclosing member. For example, alternate embodiments include support systems 100, 200 and 300 with bracket 110, 210 and 310, and without enclosing members 120, 220 or 320. These embodiments may be useful, for example, in assisting a user installing an extended shaft when the upper retention offered by the enclosing member is not needed, such as with a stationary transmission, when there is little or no upward movement of the shaft during use, when there are other devices restricting upward movement of the shaft, and/or when the support is used only to assist with installation.

Reference systems that may be used herein can refer generally to various directions (e.g., top, bottom, forward and rearward), which are merely offered to assist the reader in understanding the various embodiments of the disclosure and are not to be interpreted as limiting. Other reference systems may be used to describe various embodiments.

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

Various aspects of different embodiments of the present invention are expressed in paragraphs X1, X2, X3, X4, X5, X6 and X7 below, as follows:

X1. One aspect of the present invention pertains to a support system for a power takeoff including a shaft, comprising a bracket including a receiving portion, the bracket configured for attachment to a transmission housing or motor vehicle frame, and an enclosing member configured for attachment to the bracket, wherein the bracket and enclosing member are configured to cooperatively surround the shaft, and wherein the bracket and enclosing member permit movement of the shaft in a direction of an axis of the shaft.

X2. Another aspect of the present invention pertains to a support system for a power takeoff including a shaft, comprising a bracket including a receiving portion, the bracket configured for attachment to a transmission housing or motor vehicle frame, and an enclosing member configured for attachment to the bracket, wherein the bracket and enclosing member are configured to cooperatively surround the shaft, and wherein the bracket retains the shaft prior to surrounding the shaft with the bracket and the enclosing member.

X3. A further aspect of the present invention pertains to a support system for a power takeoff including a shaft including a bracket configured for attachment to a transmission housing, and means for restricting movement of the shaft in a radial direction while allowing movement of the shaft in an axial direction.

X4. Another aspect of the present invention pertains to a support system for a power takeoff including a bracket configured for attachment to a transmission housing, and means for retaining the shaft and inhibiting lateral movement of the shaft when the bracket is attached to the transmission housing.

X5. A further aspect of the present invention pertains to a support system for a power takeoff including a bracket including a receiving portion, wherein the bracket configured for attachment to a transmission housing or motor vehicle frame, and wherein the bracket includes a raised end configured to retain the shaft and resist lateral movement of the shaft when the bracket is attached to the transmission housing.

X6. Another aspect of the present invention pertains to a method including providing a bracket including a receiving portion, providing an enclosing member configured for attachment to the bracket, attaching the bracket to a transmission housing, providing a shaft having an axis and a circumference perpendicular to the axis of the shaft, positioning the shaft on the receiving portion wherein the bracket supports the shaft, and attaching the enclosing member to the bracket wherein the bracket and the enclosing member cooperatively surround the circumference of the shaft.

X7. A further aspect of the present invention pertains to a method including providing a bracket including a receiving portion, attaching the bracket to a transmission housing, providing a cylindrical shaft having a circumference, positioning the shaft on the receiving portion wherein the bracket supports the shaft, providing an enclosing member configured for attachment to the bracket, and attaching the enclosing member to the bracket wherein the bracket and the enclosing member cooperatively surround the circumference of the shaft.

Yet other embodiments include the features described in any of the previous statements X1, X2, X3, X4, X5, X6, or X7 as combined with
(i) one or more of the previous statements X1, X2, X3, X4, X5, X6, or X7
(ii) one or more of the following aspects, or
(iii) one or more of the previous statements X1, X2, X3, X4, X5, X6, or X7 and one or more of the following aspects:

Wherein the bracket is substantially J-shaped.

Wherein the bracket is substantially the mirror image of a J-shape.

Wherein the receiving portion of the bracket is substantially U-shaped.

Wherein the enclosing member is substantially C-shaped.

Wherein the shaft is cylindrically-shaped and includes a circumference perpendicular to the direction of the axis of the shaft, and wherein bracket and the enclosing member cooperatively surround the circumference of the shaft.

Wherein the receiving portion supports the shaft.

Wherein the bracket and enclosing member cooperatively form a substantially d-shaped structure including an opening, and wherein the shaft extends through the opening.

Wherein the enclosing member is hingedly attached to the bracket.

Wherein the bracket contacts the shaft at a longitudinal station between a transmission mounting gear and a PTO.

Wherein the bracket contacts the shaft at a longitudinal station between a transmission mounting gear and a PTO clutch plate.

Wherein the bracket contacts the shaft at a longitudinal station between a PTO clutch plate and a driven device.

Wherein the bracket contacts the shaft at a longitudinal station between a PTO and a driven device.

Wherein the shaft is positioned on the receiving portion prior to surrounding the shaft with the bracket and the enclosing member.

Wherein the bracket includes a raised end.

Wherein the bracket includes two raised ends, one located on either side of the receiving portion.

Wherein the bracket includes a raised end configured to retain the shaft and resist lateral movement of the shaft when the bracket is attached to the transmission housing.

Wherein the bracket retains the shaft prior to surrounding the shaft with the bracket and the enclosing member.

Wherein the shaft is enclosed within a shaft housing.

Wherein the shaft is at least partially enclosed within a shaft housing.

Wherein the shaft is at least partially enclosed within a cylindrically-shaped shaft housing.

Wherein the shaft includes a non-rotating housing at least partially enclosing a rotating shaft.

Wherein the bracket retains the shaft housing prior to at least partially enclosing the shaft within the shaft housing.

Wherein the support system consists of only the bracket, the enclosing member, and fasteners therefor.

Wherein the support system reduces the bending moment on the transmission housing.

Wherein the power takeoff is attached to the transmission housing and the shaft extends from the power takeoff to a driven device.

Wherein the bracket and enclosing member are sized to accommodate typical transmission and PTO system manufacturing tolerances.

Wherein the shaft is at least partially enclosed within a cylindrically-shaped shaft housing, and wherein the shaft housing includes a circumference perpendicular to the direction of an axis of the shaft housing, and wherein the bracket and the enclosing member cooperatively surround the circumference of the shaft housing.

Wherein the receiving portion includes a cutout.

Wherein the receiving portion includes a saddle received by the cutout, the saddle configured to fit between the bracket and the shaft.

Wherein the enclosing member includes a cutout.

Wherein the enclosing member includes a saddle received by the cutout, the saddle configured to fit between the bracket and the shaft.

Wherein at least one of the receiving portion and the enclosing member includes a cutout.

Wherein the at least one of the receiving portion and the enclosing member further includes a saddle received by the cutout.

Wherein the saddle is configured to fit between the bracket and the shaft.

Wherein the saddle is formed of a low-friction material.

Wherein the saddle includes a low-friction coating.

1. A support system for a power takeoff including a shaft, comprising:
a bracket including a receiving portion, the bracket configured for attachment to a transmission housing; and
an enclosing member configured for attachment to the bracket;
wherein the bracket and enclosing member are configured to cooperatively surround the shaft, and
wherein the bracket and enclosing member permit movement of the shaft in a direction of an axis of the shaft.

2. The support system of claim 1, wherein the bracket is substantially J-shaped.

3. The support system of claim 1, wherein the enclosing member is substantially C-shaped.

4. The support system of claim 1, wherein the shaft is cylindrically-shaped and includes a circumference perpendicular to the direction of the axis of the shaft, and wherein the bracket and the enclosing member cooperatively surround the circumference of the shaft.

5. The support system of claim 4, wherein the shaft is at least partially enclosed within a cylindrically shaped shaft housing, and wherein the shaft housing includes a circumference perpendicular to the direction of an axis of the shaft housing, and wherein the bracket and the enclosing member cooperatively surround the circumference of the shaft housing.

6. The support system of claim 1, wherein the receiving portion supports the shaft.

7. The support system of claim 1, wherein the bracket and enclosing member cooperatively form a substantially d-shaped structure including an opening, and wherein the shaft extends through the opening.

8. The support system of claim 7, wherein the enclosing member is hingedly attached to the bracket.

9. The support system of claim 1, wherein the bracket contacts the shaft at a longitudinal station between a power takeoff and a driven device.

10. The support system of claim 1, wherein the shaft is positioned on the receiving portion prior to surrounding the shaft with the bracket and the enclosing member.

11. The support system of claim 1, wherein the bracket includes a raised end configured to retain the shaft and resist lateral movement of the shaft when the bracket is attached to the transmission housing.

12. The support system of claim 1, wherein the bracket retains the shaft prior to surrounding the shaft with the bracket and the enclosing member.

13. The support system of claim 1, wherein the receiving portion is configured and adapted to retain the housing while the shaft is placed within the housing.

14. The support system of claim 1, wherein at least one of the receiving portion and the enclosing member includes a cutout.

15. The support system of claim 14, wherein the at least one of the receiving portion and the enclosing member further includes a saddle received by the cutout.

16. A support system for a power takeoff including a shaft, comprising:
a bracket including a receiving portion, the bracket configured for attachment to a transmission housing; and
an enclosing member configured for attachment to the bracket;
wherein the bracket and enclosing member are configured to cooperatively surround the shaft, and
wherein the bracket retains the shaft prior to surrounding the shaft with the bracket and the enclosing member.

17. The support system of claim 16, wherein the power takeoff is attached to the transmission housing prior to the bracket retaining the shaft.

18. A support system for a power takeoff including a shaft, comprising:
a bracket configured for attachment to a transmission housing; and
means for restricting movement of the shaft in a radial direction while allowing movement of the shaft in an axial direction.

19. A method comprising:
providing a bracket including a receiving portion;
providing an enclosing member configured for attachment to the bracket;
attaching the bracket to a transmission housing;
providing a shaft having an axis and a circumference perpendicular to the axis of the shaft;
positioning the shaft on the receiving portion wherein the bracket supports the shaft; and
attaching the enclosing member to the bracket wherein the bracket and the enclosing member cooperatively surround the circumference of the shaft.

20. The method of claim 19, wherein the shaft is at least partially enclosed within a cylindrically-shaped shaft housing.

21. The method of claim 19, wherein the bracket contacts the shaft at a longitudinal station between a power takeoff and a driven device.

22. The method of claim 19, wherein the shaft is at least partially enclosed within a cylindrically-shaped shaft housing, and wherein the shaft housing includes a circumference perpendicular to the direction of an axis of the shaft housing, and wherein the bracket and the enclosing member cooperatively surround the circumference of the shaft housing.
